(19) United States
(12) Patent Application Publication
(10) Pub. No.: US 2005/0190393 A1
(43) Pub. Date: Sep. 1, 2005

(54) Programmable controller system and method for supporting various operational modes in peripheral devices

(75) Inventors: James Daren Bledsoe, Albany, OR (US); Gregory Frank Carlson, Corvallis, OR (US); Todd Alan McClelland, Corvallis, OR (US); Patrick A. Mckinley, Corvallis, OR (US)

Correspondence Address: AGILENT TECHNOLOGIES, INC.;Legal Department, DL 429, Intellectual Property Administration, P.O. Box 7599, Loveland, CO, 80537-0599, US

(73) Assignee: AGILENT TECHNOLOGIES, INC., Loveland, CO (US)

(21) Appl. No.: 10/788,519

(22) Filed: Feb. 27, 2004

(51) Int. Cl. G06F 15/00

(52) U.S. Cl. 358/1.13; 358/1.15

(57) ABSTRACT

A system and method of operating a peripheral device in a plurality of functional modes is disclosed. The device may be part of a computer system including a host computer and the method includes selecting a functional mode of the device. In response to the selection of the functional mode, firmware is transferred to the device, the firmware corresponding to the selected functional mode. The firmware is stored in the device and is executed in the device to operate the device in the selected functional mode. The device may be a printer or other peripheral device having a plurality of functional modes.

### BACKGROUND OF THE INVENTION

A computer system typically includes one or more printers that image a pattern onto a print medium such as paper, allowing users of the system to “print” hardcopies of various types of documents. Becoming increasingly popular in personal computer systems are multimode printers which, in addition to printing documents, also provide other functionality such as scanning, copying, and faxing of documents. A typical multimode printer includes a controller which performs image processing of images being processed by the printer and which also controls the operation of printing, scanning, copying, and faxing subsystems contained in the printer. The controller also communicates with a host computer system to which the printer is connected to receive image data to be printed and also to receive control inputs that control the operation of the multimode printer in the various operating modes. For example, a user of the host computer system may set the resolution of an image to be scanned during a scanning mode of operation or adjust the colors of contrast of a copy being made.

The controller typically is formed from an application specific integrated circuit (ASIC) including a reduced instruction set computing (RISC) processor and custom image processing circuitry that operate in combination to execute various control and imaging processes to control the overall operation of the multimode printer. Typical imaging processes may include conversion from the red-green-blue (“RGB”) color space to the cyan, magenta, yellow, and black (“CYMK”) color space along with scaling and gamma conversion of the input image data, as will be appreciated by those skilled in the art. Typical control processes include control of the mechanical components of the printer subsystem, such as paper feeders and a print head, and the control of a scanning head during scanning of a document along with the generation of a corresponding image file.

Conventional multimode printers have a fixed set of functionality defined by the firmware stored in memory in the printer and driver software running on the host computer system. The controller ASIC executes software instructions corresponding to the firmware so that the firmware and driver software collectively define the functionality of the printer. In such a system, an overall set of functions of the printer are fixed, with specific parameters then being selected and adjusted to control the various functions of the printer. As a result, the firmware executed by the controller in the printer must support all functions in this overall set, regardless of whether a particular function is being used at a given point in time. This results in more complex firmware and driver software to support this overall set of functions. More complex software and firmware may also necessitate a more complex controller ASIC in the form of a more complex image processing circuitry and a more powerful RISC processor. Furthermore, the more complex firmware increases the required capacity of memory in the printer for storing the firmware. A more complex controller and increased memory requirements all increase the cost of the printer. Moreover, in such a conventional multimode printer the operation of the printer controller and thus the set of overall functions supported by the printer are limited to a predefined set. The firmware for this set of functions must be stored in memory and available for execution by the controller even though only a small portion of the firmware corresponding to selected functions will actually be executing at any give point in time. Although the above description is directed to multimode printers, the concepts apply equally well to other peripheral devices in computer systems. For example, in a single mode printer which only prints documents the firmware for all the various functional modes, such as draft, letter quality, color, black and white, etc., must all be stored in the controller in the printer.

There is a need for a reducing the cost of a printer or other peripheral device while also providing for flexible functionality of the device.

### SUMMARY OF THE INVENTION

One aspect of the present invention is a method of operating a peripheral device in a plurality of functional modes. The device may be part of a computer system including a host computer and the method includes selecting a functional mode of the device. In response to the selection of the functional mode, firmware is transferred to the device, the firmware corresponding to the selected functional mode. The firmware is stored in the device and is executed in the device to operate the device in the selected functional mode. The device may be a printer or other peripheral device having a plurality of functional modes.

### BRIEF DESCRIPTION OF THE DRAWINGS

FIG. 1 is a functional block diagram of a computer network including a printer containing a programmable print controller according to one embodiment of the present invention.

FIG. 2 illustrates a process executed by a printer program running on a host computer 106 in the computer network of FIG. 1 and the programmable print controller in the printer for transferring selected firmware to the programmable print controller according to one embodiment of the present invention.

FIG. 3 is a flow chart illustrating an update routine executed during the process of FIG. 2 for determining whether updated version of the firmware and the printer program are available and for downloading such firmware and printer program to the computer.

### DETAILED DESCRIPTION OF PREFERRED EMBODIMENTS

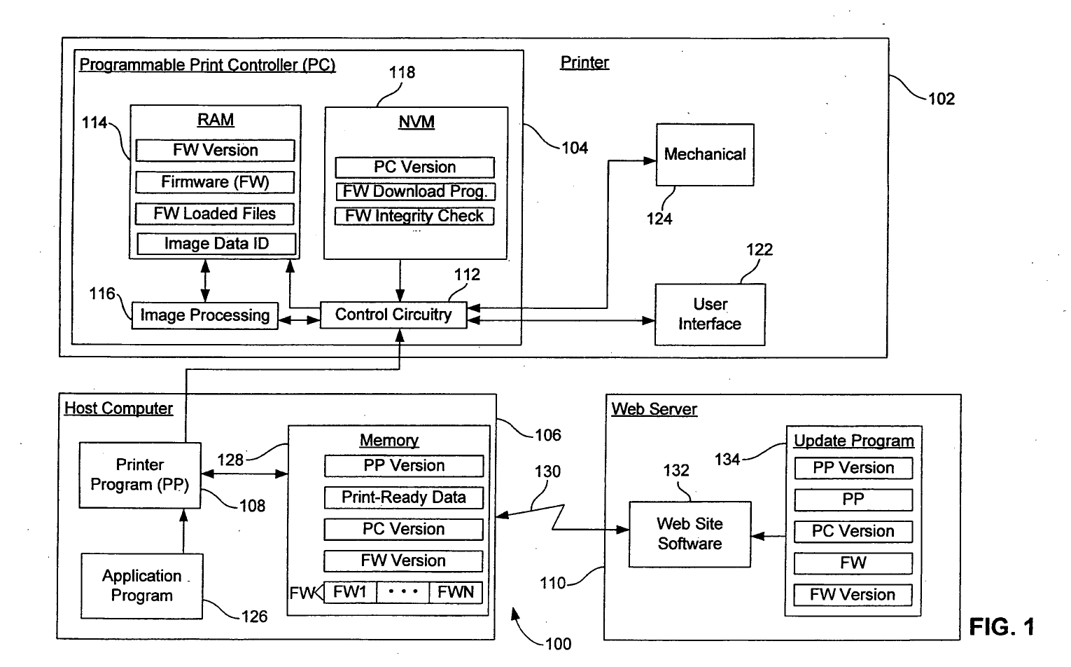

FIG. 1 is a functional block diagram of a computer network 100 including a printer 102 containing a programmable print controller 104 executing selected firmware to control the operation of the printer according to one embodiment of the present invention. The computer network 100 includes a host computer 106 that executes a printer program 108 which communicates with the programmable print controller 104 to transfer selected firmware and print data to the printer, and which also communicates with a Web server 110 to provide updated versions of selected firmware to the printer program and to install updated versions of the print program itself on the host computer, as will be explained in more detail below. In the network 100, the printer 102 need only contain enough memory to store the firmware for any single function to be executed by the programmable print controller 104, reducing the overall capacity of memory required when compared to a conventional printer since the firmware for all functional modes of the printer need not all be stored in the printer. Moreover, the programmable print controller 104 allows for dynamic operation of the printer 102 since the firmware transferred to the controller can be updated. This allows the quality of operation of the printer 102 to be enhanced and new features to be added to the overall functionality of the printer.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail to avoid unnecessarily obscuring the present invention.

The programmable controller 104 includes control circuitry 112 that communicates with the printer program 108 executing on the host computer 106. The control circuitry 112 also executes firmware FW stored in a random access memory (RAM) 114 and generates a plurality of control signals to control the operation of the printer 102. Also stored in the RAM 114 is a version indicator “FW Version” indicating the version of the firmware being executed by the circuitry 112 along with a flag “FW Loaded Flag” indicating whether firmware is currently loaded in the RAM. The RAM 114 also stores image data ID which is processed by image processing circuitry 116 under control of the control circuitry 112, as will be described in more detail below.

The controller 104 further includes nonvolatile memory 118 that includes a plurality of programs and parameters executed and utilized by the circuitry 112 in controlling the operation of the printer 102. Stored in the nonvolatile memory 118 is a firmware download program FW Download Program that the circuitry 112 executes to download firmware FW from the host computer 106 and store the firmware in the RAM 114. The circuitry 112 also executes an integrity check program FW Integrity Check stored in the nonvolatile memory 118 to verify the validity or integrity of the firmware FW stored in the RAM 114 prior to executing that firmware. The nonvolatile memory 118 also stores data PC Version indicating the current version of the programmable controller 114.

The control circuitry 112 also controls mechanical components 122 to generate an image corresponding to the image data ID. For example, the mechanical components 122 would typically include a print head for transferring ink onto paper and a paper feeder, and the control circuitry develops signals to control the operation of the mechanical components in printing an image on a piece of paper. The printer 102 further includes a user interface 124 that allows a user of the printer to provide selection inputs to control the operation of the printer. For example, the user interface 124 would typically include buttons that allow a user to turn the printer 102 on and off, to pause a print job, and so on, and may also include buttons to allow a user to apply a functional mode request to select a desired functional mode of the printer, such as a print, scan, copy, or fax mode where the print controller 104 and mechanical components 122 include subsystems to support these different functional modes of operation.

The host computer 106 includes the printer program 108 which receives data to be printed from an application program 126 running on the host computer, and processes this data to transform the data into Printer-Ready Data that is stored in a memory 128 and thereafter transferred to the control circuitry 112 in the printer 102 for storage in the RAM 114. In addition, the printer program 108 also accesses data and programs stored in the memory 128 to control the transfer of selected firmware FW to the printer 102 in response to the selection inputs. The selection inputs may be received from the circuitry 112 in the printer 102 where a user selects a functional mode via the user interface 124, or the selection inputs may be applied to the printer program 108 by a user of the host computer 106. The data stored in the memory 128 includes PP Version indicating the current version of the printer program 108, PC Version indicating the current version of the programmable controller 104 in the printer 102, and FW Version indicating the current version of the firmware that can be transferred to the programmable controller for execution. The operation of the printer program 108 in utilizing these various fields of data stored in the memory 128 will be described in more detail below. The actual firmware FW that may be transferred to the programmable controller 104 for execution is also stored in the memory 128, and is indicated as being formed by a plurality of individual firmware segments FW1-FWN. Depending upon the selected functional mode of the printer 102, only the corresponding one or ones of these firmware segments FW1-FWN are transferred to the controller 104 in the printer 102 for storage in the RAM 114, as will also be explained in more detail below.

In the computer network 100, the Web server 110 communicates with the host computer 106 through a suitable communications network 130, such as the Internet. The server 110 includes Web site software 132 for interfacing with the host computer 106 and other computers communicating with the Web site corresponding to the web site software. The Web site software 132 allows the printer program 108 either automatically or under control of a user of the host computer 106 to access the server 110 and determine whether updates of the printer program 108 or firmware FW for the printer 102 are available. When such updates are available, the Web site software 132 transfers an update program 134 to the host computer 106. This update program 134 includes the latest versions of the firmware FW, printer program 108, which is designated PP in the memory 134, along with the latest versions of the firmware and printer program and the versions of the printer controller 104 with which these latest versions are compatible.

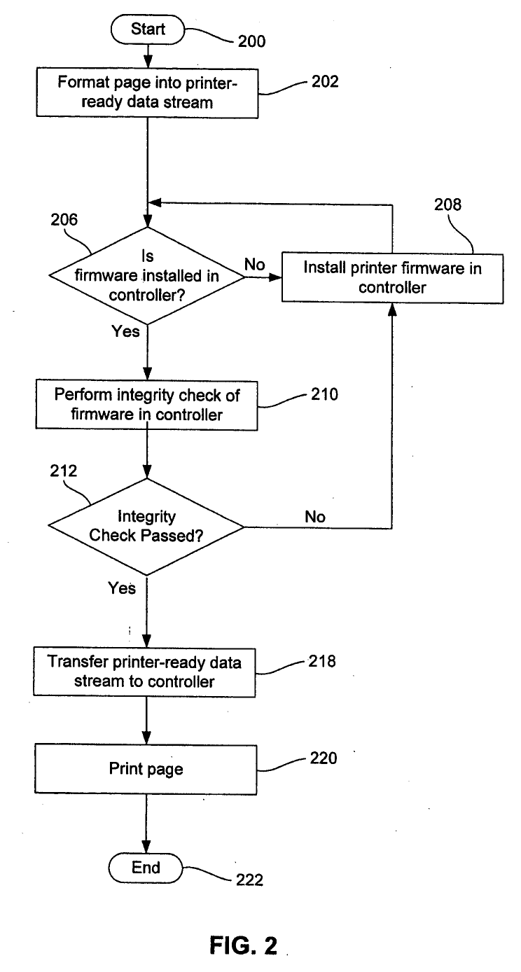

The overall operation of the computer network 100 of FIG. 1 will now be described in more detail with reference to FIG. 1 and to the flowchart of FIG. 2 FIG. 2 illustrates a process executed by the printer program 108 running on the host computer 106 and the programmable print controller 104 in the printer 102 for transferring selected firmware FW to the programmable print controller according to one embodiment of the present invention. Prior to the process of FIG. 2 starting, it is assumed the application program 126 on the host computer 106 has provided data to be printed to the printer program 108 and/or a functional request corresponding to functional mode in which the printer 102 is to operate has been supplied to the printer program. For example, where the printer 102 is a multimode printer and includes scanning and copying functionality, the functional request from the application program 126 may correspond to a request generated by the printer program 108 to place the printer 102 into either the scan or copy functional mode of operation. In the following description, the functional mode of the printer 102 is assumed to be a print mode in which data supplied from the application program 126 is to be printed.

When this occurs, the process starts in step 200 and proceeds to step 202 in which the printer program 108 formats the received data into a printer-ready form that may be processed by the programmable print controller 104. For example, the printer program 108 may format the data to be printed according to a page description language (PDL) such as the Printer Control Language (PCL) utilized by Hewlett-Packard or Postscript language utilized by Adobe, as will be appreciated by those skilled in the art.

The process then goes to step 206 and the printer program 108 and circuitry 112 communicate to determine whether the firmware segment FW1-FWN corresponding to the selected functional mode of the printer 102 is already stored in the RAM 114 in the programmable print controller 104. To make this determination, the circuitry 112 reads the FW Loaded Flag stored in the RAM 114 and determines whether this flag is set indicating the firmware is loaded into the RAM or whether the flag is reset indicating the firmware is not loaded. If the determination is negative, the process goes to step 208 and the firmware segment FW1-FWN corresponding to the selected functional mode of the printer 102 is transferred to the processing control circuitry 112 which, in turn, stores the firmware in the RAM 114 and sets the FW Loaded Flag. The process then returns to step 206 where the determination of whether the proper firmware segment FW1-FWN is stored in the controller 104 is now positive and the process then proceeds to step 210. If the determination in step 206 is initially positive, then the process proceeds immediately to step 210.

In step 210, the circuitry 112 executes the FW Integrity Check program to verify the integrity of the firmware segment FW1-FWN stored in the RAM 114 prior to executing this firmware segment, and provides an indication of the results of this integrity check to the software program 108. The process goes to step 212 and determines whether the integrity check was successful. If the integrity check was unsuccessful, indicating an error in the firmware segment FW1-FWN stored in the RAM 114, the process returns to step 208 and the firmware segment is once again transferred to the processing control circuitry 112. If the integrity check is successful, the process proceeds to step 218.

The printer program 108 then transfers the print-ready data stored in the memory 128 to the RAM 114 under control of the control circuitry 112. This print-ready data is stored in the RAM 114 as the image data ID and the image processing circuitry 116 then processes this data for printing. This processing would normally include steps such as color space conversions, image enhancements, and the execution of other algorithms necessary to prepare the data for printing, as will be appreciated by those skilled in the art. In one embodiment, the image processing circuitry 116 includes a digital signal processor for performing such image processing. The use of a digital signal processor provides flexibility in the operation and performance of the printer 102 since the image processing firmware FW for a given function (or combination of functions) can be downloaded into the controller 104 as needed. In another embodiment of the image processing circuitry 116, the circuitry includes multiple digital signal processors operating in parallel to perform the required image processing. Parallel processing of the print-ready data improves the speed of the printer 102.

Once the desired data has been printed on one or more pages in step 220, the process goes to step 222 and terminates. In one embodiment, when the process terminates in step 220 the control circuitry 112 deletes the firmware segment FW1-FWN stored in the RAM 114 in anticipation of another functional mode of operation of the printer 102 being selected.

With the programmable print controller 104, the printer 102 need only contain enough memory to store the specific firmware segment FW1-FWN currently being executed by the programmable print controller 104. In this way, the programmable print controller 104 allows only the firmware segment FW1-FWN corresponding to the selected functional mode of operation to be stored in the RAM 114 to operate the printer 102 in this functional mode. In contrast, with a conventional printer the firmware for all functional modes of the printer are stored in memory in the printer and only portions of this firmware are executed at any given time in response to the selected functional mode of operation. The programmable print controller 104 reduces the required capacity of the RAM 114 when compared to a conventional printer because only the firmware segment FW1-FWN for the selected functional mode must be stored in the RAM 114. As previously mentioned, the programmable print controller 104 also allows for dynamic operation of the printer 102 since the firmware segments FW1-FWN transferred to the controller 112 can be updated to improve the quality of operation of the printer 102 or to enhance or add features to overall functionality of the printer.

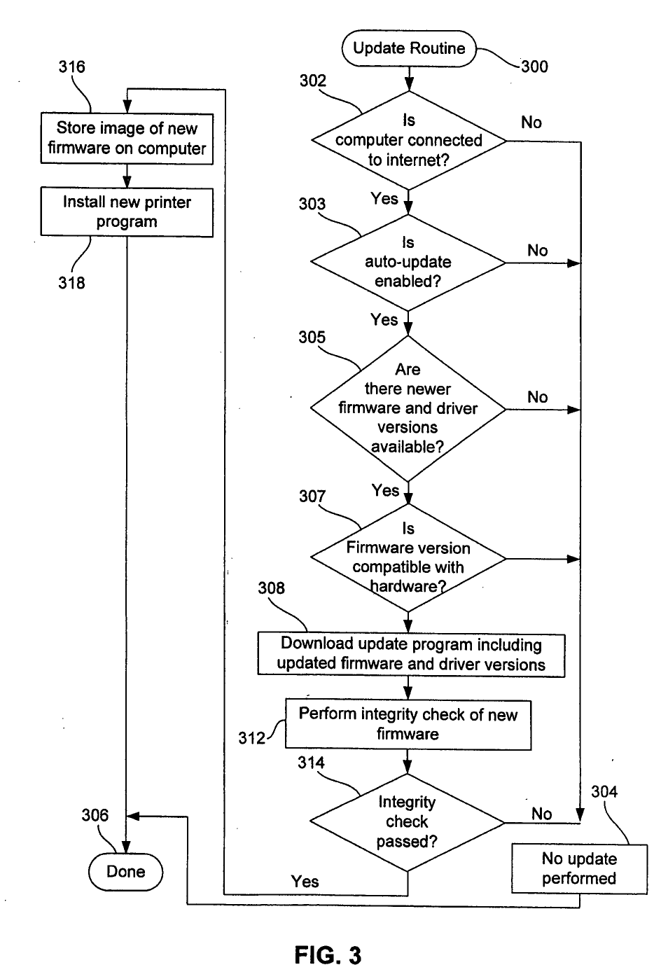

FIG. 3 is a flow chart illustrating an update routine executed by the printer program 108 of FIG. 2 for determining whether updated versions of the firmware FW and the printer program are available, and for downloading such firmware and printer program to the host computer 106. Typically, this update routine would only be executed occasionally. For example, perhaps the update routine would execute every day at a predetermined time when it is unlikely a user will be using the host computer 106, such as at 3:00 AM when the user is sleeping or at 1:00 PM when the user is at work. The update routine could, of course, be executed in response to other conditions as well. The flowchart of FIG. 3 will now be explained with reference to FIGS. 1-3. The update routine starts in step 300 and goes to step 302 to determine whether the host computer 106 is connected to the Internet 130. If the computer 106 is not connected to the Internet 130, then no updates may be downloaded from the Web server 110 and the process goes to step 304 and then terminates in step 306. If the computer 106 is connected to the Internet 130, the update routine then determines whether an auto-update feature of the printer program 108 is enabled in step 303. The user of the host computer 106 can disable the auto-update feature if automatic updates for the printer program 108 and firmware FW are not desired, and in this case the process once again goes to step 304 and 306 and terminates.

When the auto-update feature is enabled, the process goes to step 305 and the printer program 108 determines whether there are updated versions of the firmware FW and printer program available. In making this determination, the printer program 108 compares the PC Version for the programmable print controller 104 in the printer 102 to the PC Versions contained on the Web server 110 for which updates are available. If there are no updated versions available, the process once again goes to step 304 and 306 and terminates. When the printer program 108 determines in step 305 that updated versions of the firmware FW and printer program are available, the update routine goes to step 307 and determines whether the firmware version FW Version of the updated firmware is compatible with the version PC Version of the print controller 104 and the version PP Version of the software program. The versions FW Version, PC Version, and PP Version are all stored in the memory 128 in the host computer 106, and the software program 108 merely compares these versions in making this determination. If the determination in step 307 is negative, the process goes to steps 304 and 306 and terminates. In this situation, the updated firmware FW from the Web server 110 is for some reason incompatible with the controller 104 and other hardware in the printer 102.

When the determination in step 307 indicates that the FW Version is compatible with the PP version and the PC Version, the process goes to step 308 and downloads these programs from the Web server 110. From step 308 the process goes to step 312 and the first thing the update routine does is to perform an integrity check of the new firmware FW stored in the memory 128 on the host computer 106. If the integrity check fails in step 314, meaning that an error exists in the updated firmware FW downloaded from the Web server 110, the process once again goes to step 304 and 306 and terminates.

When step 314 determines the integrity check of the new firmware FW has passed, indicating no errors in the updated firmware FW downloaded from the Web server 110, the process goes to step 316 and the update routine stores a copy of the updated firmware FW in the memory 128 on the host computer 106. At this point, the update routine installs the updated version of the printer program 108 on the host computer 106 and initiates execution of this new version of the printer program. The updated version of the printer program 108 now executes on the host computer 106, and the process then goes to step 306 and terminates.

Even though various embodiments and advantages of the present invention have been set forth in the foregoing description, the above disclosure is illustrative only, and changes may be made in detail and yet remain within the broad principles of the present invention. Moreover, the functions performed by the blocks illustrated in FIG. 1 can be combined to be performed by fewer elements, separated and performed by more elements, or combined into different functional blocks depending upon the actual components used in the printer 102 and computer network 100, as will appreciated by those skilled in the art. Therefore, the present invention is to be limited only by the appended claims.

1. A peripheral device, comprising:
peripheral circuitry operable to perform a desired function responsive to control signals; and
a programmable controller adapted to receive and store firmware that is selected in response to a functional mode request, and the controller being further operable to execute the stored firmware and to develop the control signals to control the peripheral circuitry in response to the executing firmware.

2. The peripheral device of claim 1 wherein the programmable controller is further operable to develop the functional mode request in response to selection inputs applied to the peripheral device.

3. The peripheral device of claim 2 wherein the peripheral circuitry comprises mechanical components.

4. The peripheral device of claim 1 wherein the functional mode request is generated external to the programmable controller.

5. The peripheral device of claim 1 wherein the peripheral device comprises a printer and wherein the peripheral circuitry comprises a print engine.

6. The peripheral device of claim 5 wherein the peripheral circuitry further comprises a scanning subsystem, copier subsystem, and a facsimile subsystem.

7. The peripheral device of claim 1 wherein the programmable controller is further operable to perform an integrity check of the firmware prior to executing the firmware.

8. The peripheral device of claim 1 wherein the functional mode request is associated with a function of the device and the function of the device is associated with the stored firmware, and wherein the programmable controller is further operable to erase the firmware when the peripheral device has performed the associated function.

9. The peripheral device of claim 1 wherein the programmable controller includes a digital signal processor for image processing of print or scanned data.

10. A computer network, comprising:
a peripheral device, comprising:
peripheral circuitry operable to perform a desired function responsive to control signals; and
a programmable controller adapted to receive and store firmware that is selected in response to a functional mode request, and the controller being further operable to execute the stored firmware and to develop the control signals to control the peripheral circuitry in response to the executing firmware; and
a computer system coupled to the programmable controller, the computer system including a software component operable to provide the firmware to the controller responsive to the functional mode request.

11. The computer network of claim 10 wherein the programmable controller is further operable to develop the functional mode request responsive to selection inputs applied to the peripheral device.

12. The computer network of claim 10 wherein the software component is further operable to develop the functional mode request responsive to selection inputs applied to the computer system.

13. The computer network of claim 12 wherein the software component is further operable to determine whether an updated version of the firmware corresponding to the functional mode request is available, and if an updated version is available to transfer the updated version to the programmable controller.

14. The computer network of claim 13 wherein the software component is further operable to access a Web site to determine whether an updated version of the firmware is available and to download the updated version to the computer system when available.

15. The computer network of claim 14 wherein the software component determines that an updated version of the firmware is available by communicating with a Web site to receive an updated version indicator from the Web site and to compare this updated version indicator to a version indicator stored on the computer system, and is further operable to download to the computer system an updated version of the firmware when available.

16. The computer network of claim 15 wherein the software component is further operable to compare a controller version indicator stored in the controller or on the computer system with a controller version indicator received from the Web site along with the updated firmware, and is operable to download the updated version of the firmware only if controller version indicators indicate the updated firmware is compatible with the controller in the peripheral device.

17. The computer network of claim 15 wherein the software component is further operable to communicate with the Web site to determine whether an updated version of the software executed by the software component is available, and to download an updated version of this software when available.

18. The computer network of claim 10 wherein the peripheral device comprises a printer.

19. A method of operating a peripheral in a computer system including a host computer, the peripheral device being operable in a plurality of functional modes and the method comprising:
selecting a functional mode of the peripheral device;
in response to the selection of the functional mode, transferring firmware to the device, the firmware corresponding to the selected functional mode;
storing the firmware in the peripheral device; and
executing the firmware in the peripheral device to operate the peripheral device in the selected functional mode.

20. The method of claim 19 wherein selecting a functional mode of the peripheral device comprises selecting in the host computer the functional mode of the device.

21. The method of claim 19 wherein selecting a functional mode of the peripheral device comprises applying selection inputs to the peripheral device to select the functional mode.

22. The method of claim 19 wherein the peripheral device comprises a printer.

23. The method of claim 22 wherein the selected mode corresponds to one of a print, scan, copy, and fax mode of operation of the peripheral device.

24. The method of claim 19 wherein executing the firmware in the peripheral device to operate the device in the selected mode comprises executing the image processing firmware in a digital signal processor contained in the device.

25. The method of claim 24 further comprising performing image processing with parallel digital signal processors.
